(19) United States
(12) Patent Application Publication
(10) Pub. No.: US 2007/0136068 A1
(43) Pub. Date: Jun. 14, 2007

(54) Multimodal multilingual devices and applications for enhanced goal-interpretation and translation for service providers

(75) Inventor: Eric J. Horvitz, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/298,219

(22) Filed: Dec. 9, 2005

(51) Int. Cl. G10L 21/00

(52) U.S. Cl. 704/270

(57) ABSTRACT

A person-to-person communications architecture for communications translation between people who speak different languages in a focused setting is described. In such focused areas, the provisioning of devices, language models and, item and context recognition can be employed by specific service providers (e.g., taxi drivers in a foreign country such as China) where language translation services are an important part of commerce (e.g., tourism). The architecture can include a communications component that facilitates communications between two people who are located in a context, a configuration component that can configure the communications component based on the context in which at least one of the two people is located, and a recognition component that captures and analyzes context data of the context, and recognizes an attribute of the context data that is processed and utilized by the configuration component to facilitate the communications between the two people.

### BACKGROUND

The advent of global communications networks such as the Internet has served as a catalyst for the convergence of computing power and services in portable computing devices. With the technological advances in handheld and portable devices, there is an ongoing and increasing need to maximize the benefit of these continually emerging technologies. Given the advances in storage and computing power of such portable wireless computing devices, they now are capable of handling many types of disparate data types such as images, video clips, audio data an textual data, for example. This data is typically utilized separately for specific purposes.

The Internet has also brought internationalization by bringing millions of network users into contact with one another via mobile devices (e.g., telephones), e-mail, websites, etc., some of which can provide some level of textual translation. For example, a user can select their browser to install language plug-ins which facilitate some level of textual translation from one language text to another when the user accesses a website in a foreign country. However, the world is also becoming more mobile. More and more people are traveling for business and for pleasure. This presents situations where people are now face-to-face with individuals and/or situations in a foreign country where language barriers can be a problem. For a number of multilingual mobile assistant scenarios, speech translation is a very high bar.

Although these generalized multilingual assistant devices can provide some degree of translation capability, the translation capabilities are not sufficiently focused to a particular context. For example, as indicated above, language plug-ins can be installed on browser that provides a limited textual translation capability directed toward a more generalized language capability. Accordingly, a mechanism is needed that can exploit the increased computing power of portable devices to enhance user experience in more focused areas of human interaction between people that speak different languages, such as in commercial contexts involved with tourism, foreign travel, and so on.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject innovation is a person-to-person communications architecture that finds application in many different areas or environments. In focused areas, the provisioning of devices, language models and, item and context recognition can be employed by specific service providers (e.g., taxi drivers in a foreign country such as China) where language translation services are an important part of commerce (e.g., tourism). There are countries that include a diverse population many of which speak different languages or dialects within a common border. Thus, person-to-person communications for purposes of security, medical purposes and commerce, for example, can be problematic in a single country.

Accordingly, the invention disclosed and claimed herein, in one aspect thereof, comprises a system that facilitates person-to-person communications in accordance with an innovative aspect. In support thereof, the system can include a communications component that facilitates communications between two people who are located in a context (e.g., a location or environment). A configuration component of the system can configure the communications component based on the context in which at least one of the two people is located. Context characteristics can be recognized by a recognition component that captures and analyzes context data of the context, and recognizes an attribute of the context data that is processed and utilized by the configuration component to facilitate the communications between the two people.

The context data can include environmental data about the current user context (e.g., temperature, humidity, levels of lightness and darkness, pressure, altitude, local structures, . . . ), time of day and day of week, the existence or nature of a holiday, recent activity by people (e.g., language of an utterance heard within some time horizon, recent gesture, recent interaction with a device or object, . . . ), recent activity by machines being used by people (e.g., support provided or accepted by a person, failure of a system to provide a user with appropriate information or services, . . . ), geographical information (e.g., geographical coordinates), events in progress in the vicinity (e.g., sporting event, rally, carnival, parade, . . . ), proximal structures, organizations, or services (e.g., shopping centers, parks, bathrooms, hospitals, banks, government offices, . . . ), and characteristics of one or more of the people in the context (e.g., voice signals, relationship between the people, color of skin, attire, body frame, hair color, eye color, facial structure, biometrics, . . . ), just to name a few types of the context data. Beyond current context, context data can include contextual information drawn from different times, such as contextual information observed within some time horizon, or at particular distant times in the past.

In yet another aspect thereof, a machine learning and reasoning (MLR) component is provided that employs a probabilistic and/or statistical-based analysis to prognose or infer an action that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates person-to-person communications in accordance with an innovative aspect.

FIG. 2 illustrates a methodology of providing person-to-person communications according to an aspect.

FIG. 3 illustrates a block diagram of a system that includes a feedback component according to an aspect.

FIG. 4 illustrates a more detailed block diagram of the communications component and configuration component according to an aspect.

FIG. 5 illustrates a more detailed block diagram of the recognition component and feedback component according to an aspect.

FIG. 6 illustrates a person-to-person communications system that employs a machine learning and reasoning component which facilitates automating one or more features in accordance with the subject innovation.

FIG. 7 illustrates a methodology of provisioning a person-to-person communications system in accordance with another aspect of the innovation.

FIG. 8 illustrates a methodology of system learning during a person-to-person communications exchange according to an aspect.

FIG. 9 illustrates a methodology of configuring a person-to-person communications system in accordance with the disclosed innovative aspect.

FIG. 10 illustrates a methodology of configuring a context system before deployment according to an aspect.

FIG. 11 illustrates a methodology of updating a language model based on local usage according to an aspect.

FIG. 12 illustrates a methodology of converging on customer physical and/or mental needs as a basis for person-to-person communications according to an innovative aspect.

FIG. 13 illustrates a system that facilitates the capture and processing of data from multiple devices in accordance with an innovative aspect.

FIG. 14 illustrates a flow diagram of a methodology of capturing logs from remote devices.

FIG. 15 illustrates a block diagram of a computer operable to execute the disclosed person-to-person communications architecture.

FIG. 16 illustrates a schematic block diagram of an exemplary computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The subject person-to-person communications innovation finds application in many different areas or environments. In focused areas, the provisioning of devices, language models and, item and context recognition can be employed by specific service providers (e.g., taxi drivers in a foreign country such as China) where translation services are an important part of commerce (e.g., tourism). There are countries that include a diverse population many of which speak different languages or dialects within a common border. Thus, person-to-person communications for purposes of security, medical purposes and commerce, for example, can be problematic in a single country.

In one implementation, there are scenarios where the indigenous people have custom-tailored devices configured to capture key questions, to interpret common answers and provide additional questions. In another exemplary implementation, a translation system for English to Chinese and back can be deployed and custom-tailored for Beijing taxi drivers. In other implementations provided by example, but not by limitation, waiters and waitresses, retail sales people, airline staff, etc., can be outfitted with customized devices that are tailored to facilitate communications and transactions between individuals that speak different languages.

Automated image analysis of customers to extract characteristics (e.g., color of skin, attire, body frame, objects being carried, voice signals, facial constructs, . . . ) can be analyzed and processed to facilitate converging on a customer's or person's ethnicity, for example, and further employing a model that will facilitate transacting with the customer (e.g., not suggesting certain food types to an individual that may practice a particular religion). Automated visual analysis can include contextual cues such as the recognition that a person is porting suitcases, and is likely in a transitioning/travel situation.

Again, the subject invention finds application as part of security systems to identify and screen persons for access and to provide general identification, for example. In that the subject innovation facilitates person-to-person communications between two people who speak different languages, and can recognize at least human features and voice signals, the quality of security can be greatly enhanced.

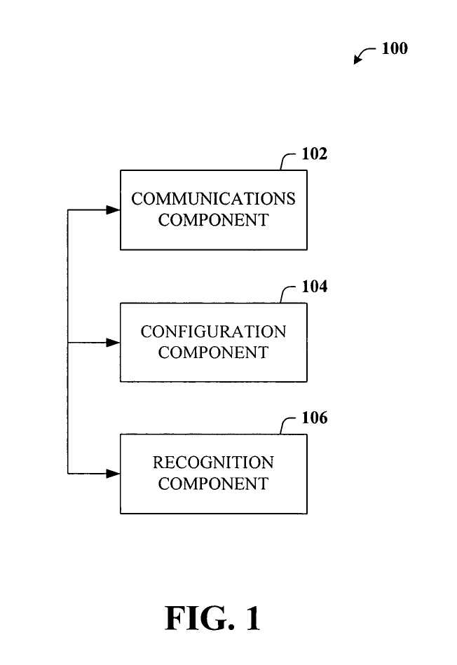

Accordingly, FIG. 1 illustrates a system 100 that facilitates person-to-person communications in accordance with an innovative aspect. In support thereof, the system 100 can include a communications component 102 that facilitates communications between two people who are located in a context (e.g., a location or environment). A configuration component 104 of the system 100 can configure the communications component 102 based on the context in which at least one of the two people is located. Context characteristics can be recognized by a recognition component 106 that captures and analyzes context data of the context, and recognizes an attribute of the context data that is processed and utilized by the configuration component 104 to facilitate the communications between the two people.

The context data can include environmental data about the current user context (e.g., temperature, humidity, levels of lightness and darkness, pressure, altitude, local structures, . . . ), characteristics of one or more of the people in the context (e.g., color of skin, attire, body frame, hair color, eye color, voice signals, facial constructs, biometrics, . . . ), and geographical information (e.g., geographical coordinates), just to name a few types of context data. Some common forms of sensing geographical coordinates such as GPS (global positioning system) may not work well indoors. However information about when signals, that had been tracked, were lost coupled with information that a device is still likely functioning, can provide useful evidence about the nature of the structure that is surrounding a user. For example, consider the case where a GPS data, reported by a device carried by a user, reports an address adjacent to a restaurant, but shortly thereafter the GPS signal is no longer detectable. Such a loss of a GPS signal followed by the location reported by the GPS system before the signal vanished may be taken as valuable evidence that a person has entered the restaurant.

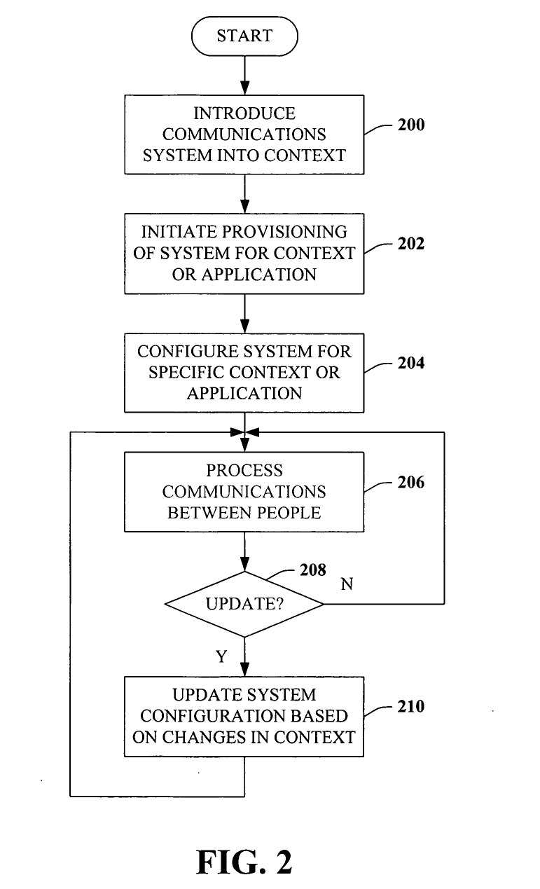

FIG. 2 illustrates a methodology of providing person-to-person communications according to an aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, the innovative communications system can be introduced into a context or environment. At 202, provisioning of the system can be initiated for the specific context or environment in which it is being deployed. For example, the specific context environment can be a commercial environment that includes transactional language between the two people such as a retailer and a customer, a waiter/waitress and a customer, a doctor and a patient, or any commercial exchange.

At 204, the system is configured for the context and/or application. At 206, the system goes operational and processes communications between two people. At 208, a check is made for updates. The updates can be for language models, questions and answers, changes in context, and so on. If an update is available, the system configuration is updated, as indicated at 210, and flow progresses back to 206 to either begin a new communications session, or adapt to changes in the existing context and automatically continue the existing session based on the updates. If an update is not available, flow proceeds from 208 to 206 to process communications between the people.

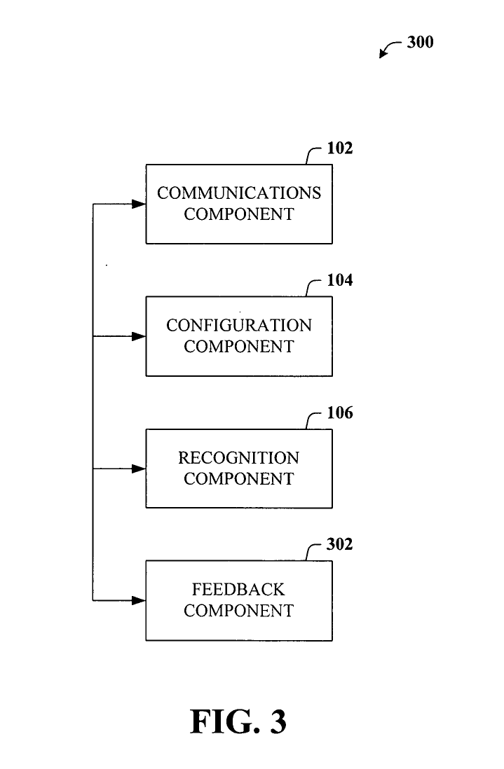

FIG. 3 illustrates a block diagram of a system 300 that includes a feedback component 302 according to an aspect. The feedback component 302 can be utilized in combination with the communications component 102, configuration component 104, and recognition component 104 of the system 100 of FIG. 1. The feedback component 302 facilitates feedback from people who can be participating in the communications exchange. Feedback can be utilized to improve the accuracy of the person-to-person communications provided by the system 300. In one implementation described infra, feedback can be provided in the form of questions and answer posed to participants in the communication session. It is to be appreciated that other forms of feedback can be provided in the form of body language a participant exhibits in response to a question or a statement (e.g., nodding or shaking of the head, eye movement, lip movement, . . . ).

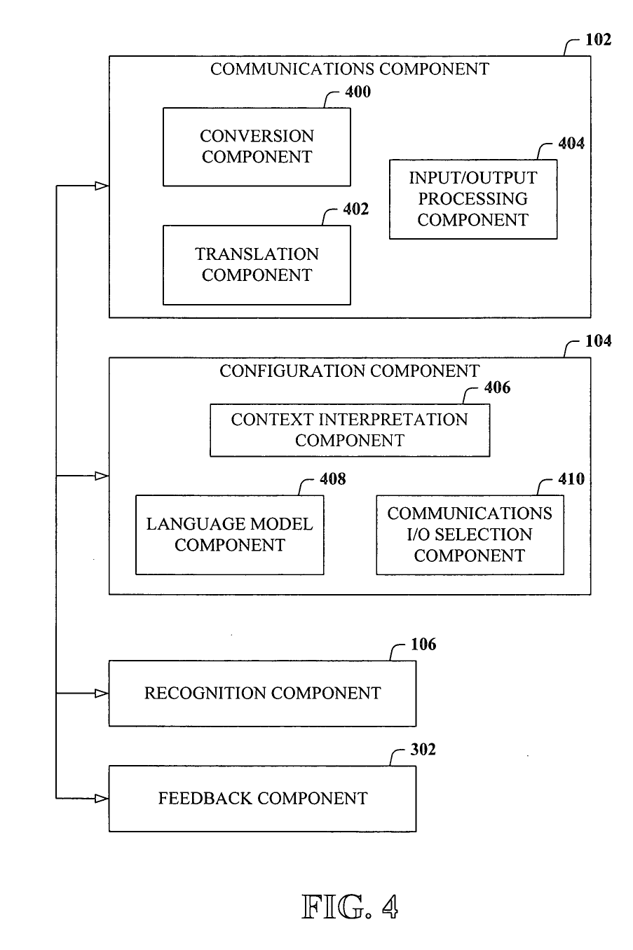

FIG. 4 illustrates a more detailed block diagram of the communications component 102 and configuration component 104 according to an aspect. The communications component 102 facilitates the input/output (I/O) functions of the system. For example, I/O can be in the form of speech signals, text, images, and/or videos, or any combination thereof such as in multimedia content insofar as it facilitates comprehendible communications between two people. In support thereof, the communications component 102 can include a conversion component 400 that converts text into speech, speech into text, an image into speech, speech into a representative image, and so on. A translation component 402 facilitates the translation of speech of one language into speech of a different language. An I/O processing component 404 can receive and process both of the conversion component output and the translation component output to provide suitable communications that can be understandable by at least one of the persons seeking to communicate.

The configuration component 104 can include a context interpretation component 406 that receives and processes context data to make a decision as to what context the system is employed. For example, if the context data as captured and processed recognizes dishes, candles, food, it can be interpreted that the context is a restaurant. Accordingly, the configuration component 104 can also include a language model component 408 that includes a number of different language models for translation by the translation component 402 into a different language. Furthermore, the language model component 408 can also include models that relate to specific environments within a given context. For example, a primary language model can facilitate translation between English and Chinese, if in China, but a secondary model can be in the context of a restaurant environment in China. Accordingly, the secondary model could include terms normally used in a restaurant setting, such as food terms, pleasantries normally exchanged between a waiter/waitress, and generally terms used in such a setting.

In another example, again in China, the primary language model is for the translation between English and Chinese languages, but now context data can further be interpreted to be associated with a taxi cab. Accordingly, the secondary language model could include terms normally associated with interacting with a cab driver in Beijing, China, such as street names, monetary amounts, directions, and so on.

In all cases, the way in which the communications are presented and received is selectable, either manually or automatically. Accordingly, the configuration component 104 can further include a communications I/O selection component 410 that controls the selection of the I/O format of the I/O processing component 404. For example, if the context is the taxi cab, it may be more efficient and safe to output the communications in speech-to-speech format rather than speech to text, since the cab driver could need to read the translated text perhaps while driving if provided in a text format.

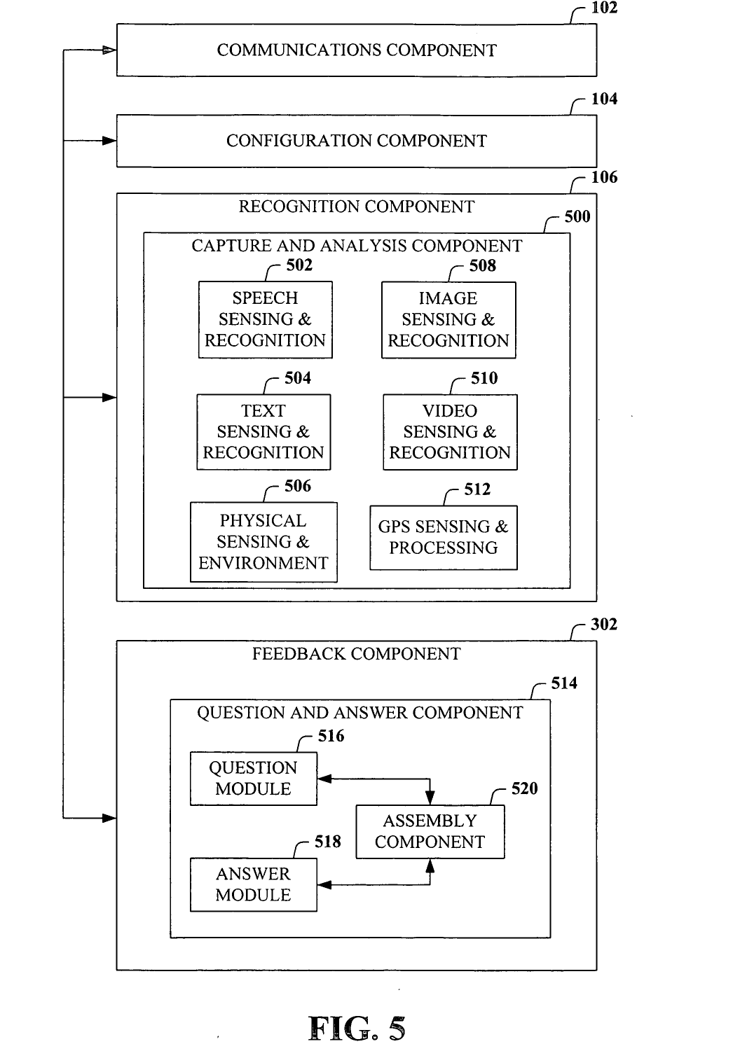

FIG. 5 illustrates a more detailed block diagram of the recognition component 106 and feedback component 302 according to an aspect. The recognition component 106 can include a capture and analysis component 500 that facilitates detecting aspects of the context environment. Accordingly, a speech sensing and recognition component 502 is provided to receive and process speech signals picked up in the context. Thus, the received speech can be processed to determine what language is being spoken (e.g., to facilitate selection of the primary language model) and more specifically, what terms are being used (e.g., to facilitate selection of the secondary language model). Additionally, such speech recognition can be employed to aid in identifying gender (e.g., higher tones or pitches infer a female, whereas lower tones or pitches infer a male).

A text sensing and recognition component 504 facilitates processing text that may be displayed or presented in the context. For example, if a placard is captured which includes the text “Fare: $2.00 per mile” it can be inferred that the context could be in a taxi cab. In another example, if the text as captured and analyzed is “Welcome to Singapore”, it can be inferred that the context is perhaps the country of Singapore, and that the appropriate English/Singapore primary language model can be selected for translation purposes.

A physical sensing and environment component 506 facilitates detecting physical parameters associated with the context, such as temperature, humidity, pressure, altitude, and biometric data such a human temperature, heart rate, skin tension, eye movement, and head movements.

An image sensing and recognition component 508 facilitates the capture and analysis of image content from a camera, for example. Image content can include facial constructs, colors, lighting (e.g., for time of day or inside/outside of a structure), text captured as part of the image, and so on. Where text is part of the image, optical character recognition (OCR) techniques can be employed to approximately identify the text content.

A video sensing and recognition component 510 facilitates the capture and analysis of video content using a camera, for example. Thus speech signals, image content, textual content, music, and other content can be captured and analyzed in order to obtain clues as to the existing context.

A geolocation sensing and processing component 512 facilitates the reception and processing of geographical location signals (e.g., GPS) which can be employed to more accurately pinpoint the user context. Additionally, the lack of geolocation signals can indicate that the context is inside a structure (e.g., a building, tunnel, cave, . . . ). When used in combination with the physical data, it can be inferred, for example, that if there are no geolocation signals received, the context can be is inside a structure (e.g., a building), and if the lighting is low, the context could be a tunnel or cave, and furthermore, if the humidity if relatively high, the context is most likely a cave. Thus, when used in combination with other data, it can be seen that context identification can be improved, in response to which language models can be employed, and other information applied to make application of the systems customized for a specific environment.

The conversion component 400 of FIG. 4 can be utilized to convert GPS coordinates into text and/or speech signals, and then translated and presented in the desired language, based on selection of the primary and secondary language models. For example, coordinates associated with 40-degrees longitude can be converted into text and displayed as “forty-degrees longitude” and/or output as speech.

The feedback component 302 can include one or more mechanisms whereby determining the context and applying the desired models for the context is improved. In one example, a question and answer subsystem 514 is provided. A question module 516 can include questions that are commonly employed for a given context. For example, if the context is determined to be a restaurant, questions such as “How much?”, “What is the catch of the day?” and “Where are the restrooms?” can be included for access and presentation. Of course, depending on the geographic location, the question would be translated into the local language for presentation (e.g., speech, text, . . . ) to a person or persons in that context (e.g., a Chinese restaurant in Beijing).

An answer module 518 can include answers to questions that are commonly employed for a given context. For example, if the context is determined to be an airplane, answers such as “I am fine”, “Nothing please” and “I am traveling to Beijing” can be included for access and presentation as answers. As before, depending on the geographic location, the answer would be translated into the local language for presentation (e.g., speech, text, . . . ) to a person or persons in that context (e.g., a Chinese flight attendant).

The question and answer component 514 can also include an assembly component 520 that assembles the questions and answers for output. For example, it is to be appreciated that both a question and a finite number of relevant preselected or predetermined answers can be computed and presented via the assembly component 514. Selection of one or more of the answers associated with a question can be utilized to improve the accuracy of the communications in any given environment in which the system is employed. Thus, where the computed output is not what is desired, the question-and-answer format can be enabled to refine the process more accurately determine aspects or characteristics of the context. For example, such refinement can lead to selection of different primary and secondary language models of the language model component 408 of FIG. 4, and the selection by the selection component 410 of FIG. 4 of different types of I/O by the I/O processing component 404 of FIG. 4.

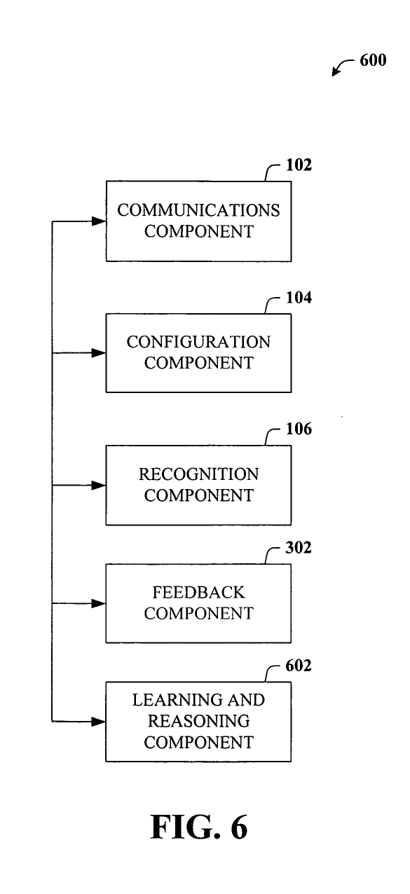

FIG. 6 illustrates a person-to-person communications system 600 that employs a machine learning and reasoning (MLR) component 602 which facilitates automating one or more features in accordance with the subject innovation. The subject invention (e.g., in connection with selection) can employ various MLR-based schemes for carrying out various aspects thereof. For example, a process for determining which primary and secondary language models to employ in a given context can be facilitated via an automatic classifier system and process. Additionally, where the processing of updates is concerned, the classifier can be employed to determine which updates to apply and when to apply them, for example.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed.

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions, including but not limited to the following exemplary scenarios.

In one implementation, based on captured speech signals from a person, the MLR component 602 can adjust or reorder the sequence of words that will ultimately be output in a language. This can be based not only on the language to be output, but the speech patterns of the individual with whom person-to-person communications is being conducted. This can further be customized for the context in which the system is deployed. For example, if the system is deployed at a customs check point, the system can readily adapt and process communications to the language spoken in the country of origin of the person seeking entry into a different country.

It is to be appreciated that in such a context, the language models employed can be switched out for each person being processed through, with adaptations or updates being imposed regularly on the system based on the person being processed into the country. Over time, the learning process utilized by the MLR component 602 will improve the accuracy of the communications not only in a single context, but data can be transmitted to similar system being employed in another part of the same country that performs a similar function, and/or even a different country that performs a similar function.

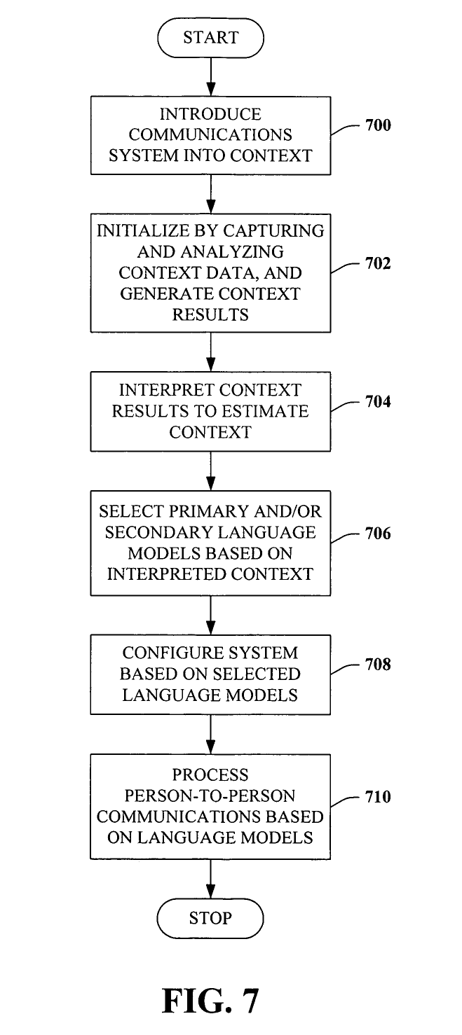

FIG. 7 illustrates a methodology of provisioning a person-to-person communications system in accordance with another aspect of the innovation. At 700, the communications system is introduced into a context. At 702, initialize by capturing and analyzing context data, and generating context results. At 704, the context results are interpreted to estimate the context. At 706, primary and/or secondary language models can be selected based on the interpreted context. At 708, the system is then configured based on the selected language models. For example, this can include selecting only text-to-text I/O in a quiet setting, rather than speech output which could be disruptive to others in the context setting. At 710, person-to-person communications can then be processed based on the language models.

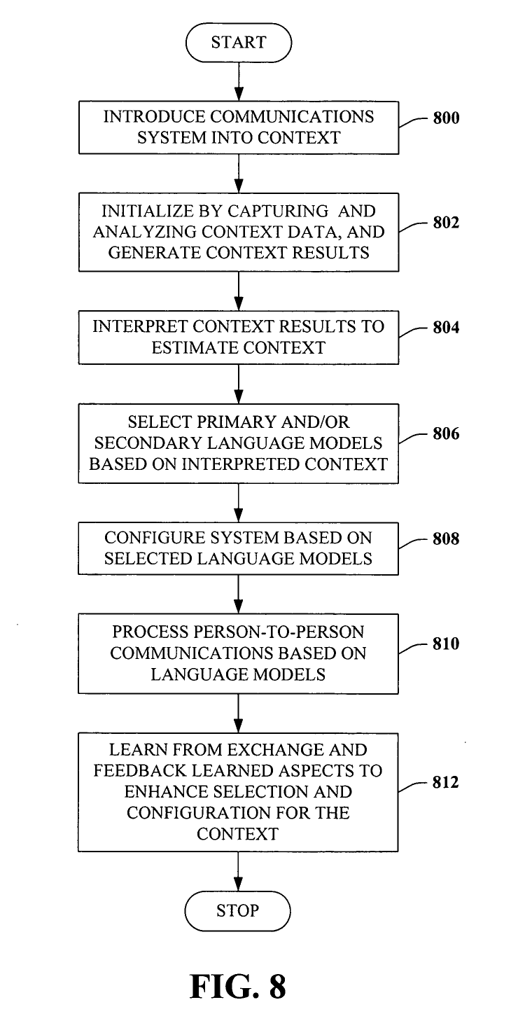

FIG. 8 illustrates a methodology of system learning during a person-to-person communications exchange according to an aspect. At 800, the communications system is introduced into a context. At 802, initialize by capturing and analyzing context data, and generating context results. At 804, the context results are interpreted to estimate the context. At 806, primary and/or secondary language models can be selected based on the interpreted context. At 808, the system is then configured based on the selected language models. For example, this can include selecting only speech-to-speech I/O in a setting where reading text could be dangerous or distractive. At 810, person-to-person communications can then be processed based on the language models. At 812, the system MLR component can facilitate learning about aspects of the exchange, such as repetitive speech or text processing which could indicate that the language models may be incorrect, or monitoring such repetitive task or interaction that frequently occurs by a user in this particular context, and thereafter automating the task so the user does not need to interact that way in the future.

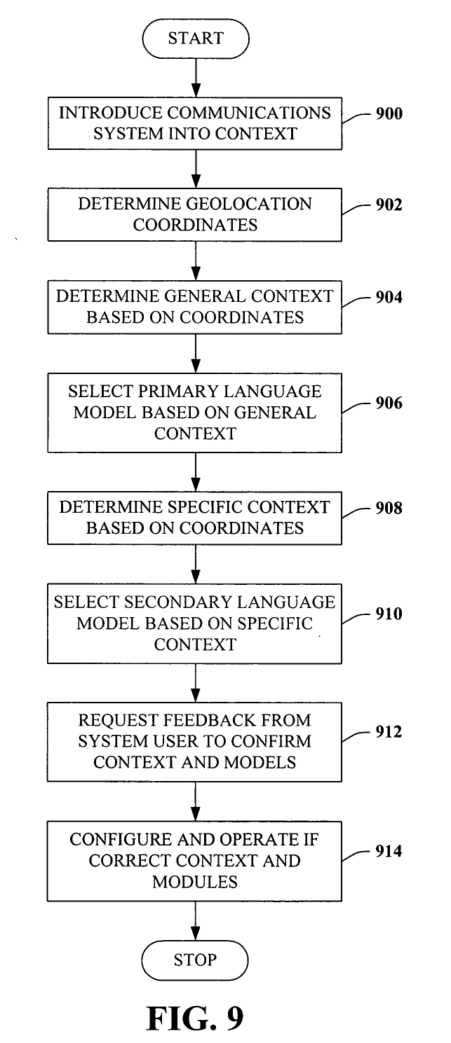

Referring now to FIG. 9, there is illustrated a methodology of configuring a person-to-person communications system in accordance with the disclosed innovative aspect. At 900, a communications system is introduced into a context. At 902, geolocation coordinates are determined. This can be via a GPS system, for example. At 904, the general context (e.g., country, state, province, city, village, . . . ) can be determined. In response to this information, the primary language model can be selected, as indicated at 906. At 908, the more specific context (e.g., taxi cab, restaurant, train station, . . . ) can be determined. In response to this information, the secondary language model can be selected, as indicated at 910. At 912, the system can initiate a request for feedback from one or more users to confirm the context and the appropriate language models. At 914, the system can then be configured into its final configuration and operated according to the selected models.

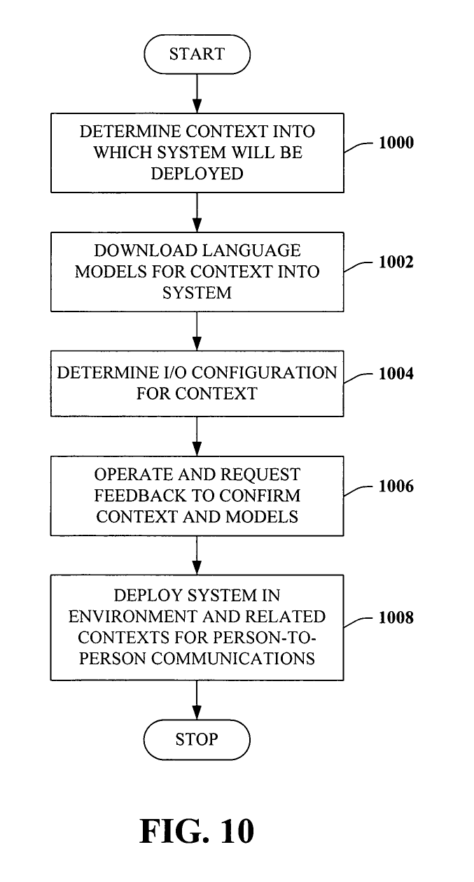

FIG. 10 illustrates a methodology of configuring a context system before deployment according to an aspect. At 1000, the user determines into which context the system will be deployed. For example, if the system will used in taxi cabs, this could define a limited number of language models that could be implemented. At 1002, the corresponding language models are downloaded into the system. At 1004, based on the known context and the language models, it can be determined which I/O configurations (e.g., text-to-speech, speech-to-speech, . . . ) should likely be utilized. At 1006, once configured, the system can be test operated. Feedback can then be requested by the system to ensure that the correct models and output configurations work best. At 1008, the system can then be deployed in the environment or context, as well as the configuration information and modules uploaded into similar systems that will be deployed in similar contexts.

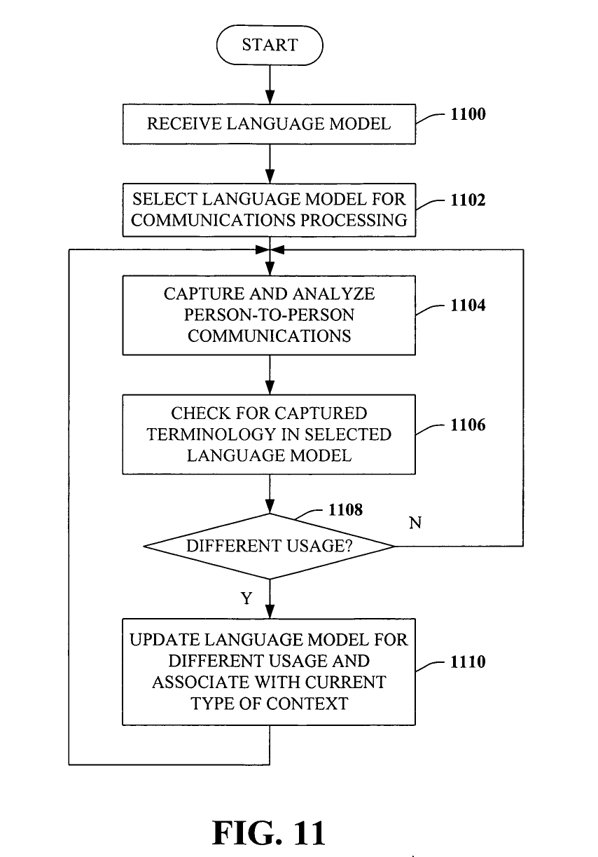

FIG. 11 illustrates a methodology of updating a language model based on local usage according to an aspect. At 1100, a language model is received. At 1102, the language model is selected and enabled for person-to-person communications processing. At 1104, capture and analysis of current person-to-person communications is performed. At 1106, the system checks for captured terminology in the selected language model. If the terminology currently detected is different than in the language model, flow is from 1108 to 1110 to update the language model for the different usage and associate the different usage with the current type of context. Flow can then proceed back to 1104 to continue monitoring the person-to-person communications exchange for other terminology. If the terminology currently detected is not substantially different than in the language model, flow is from 1108 back to 1104 to continue monitoring the person-to-person communications exchange for other terminology. As described herein, the terminology can be in different languages as processed from speech signals as well as text information.

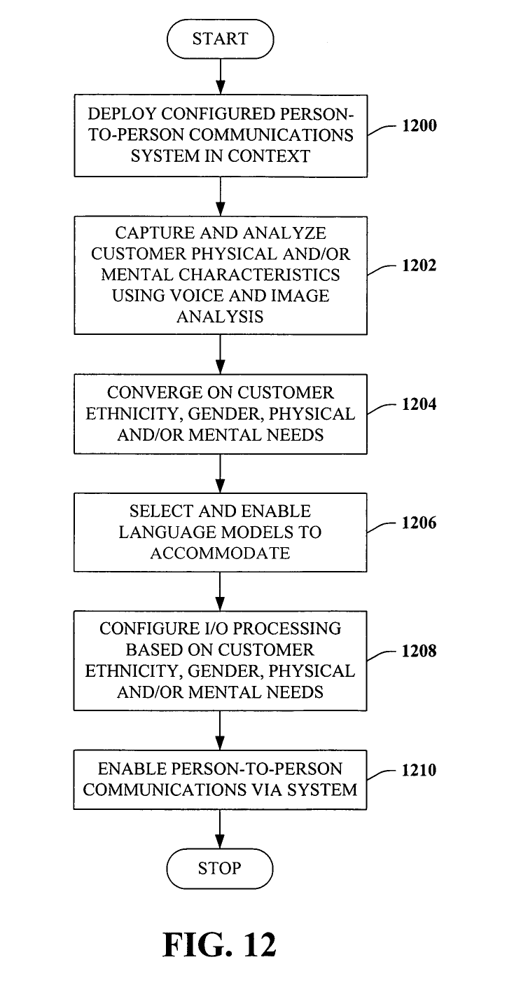

FIG. 12 illustrates a methodology of converging on customer physical and/or mental needs as a basis for person-to-person communications according to an innovative aspect. At 1200, a configured person-to-person communications system is deployed in a context. At 1202, customer physical and/or mental characteristics are captured and analyzed using at least one of voice and image analysis. At 1204, based on these estimated characteristics, customer ethnicity, gender and, physical and/or mental needs are converged upon via data analysis. At 1206, suitable language models are selected and enabled to accommodate these estimated characteristics. At 1208, I/O processing is configured based on the customer ethnicity, gender and, physical and/or mental needs. At 1210, person-to-person communications is then enabled via the communications system.

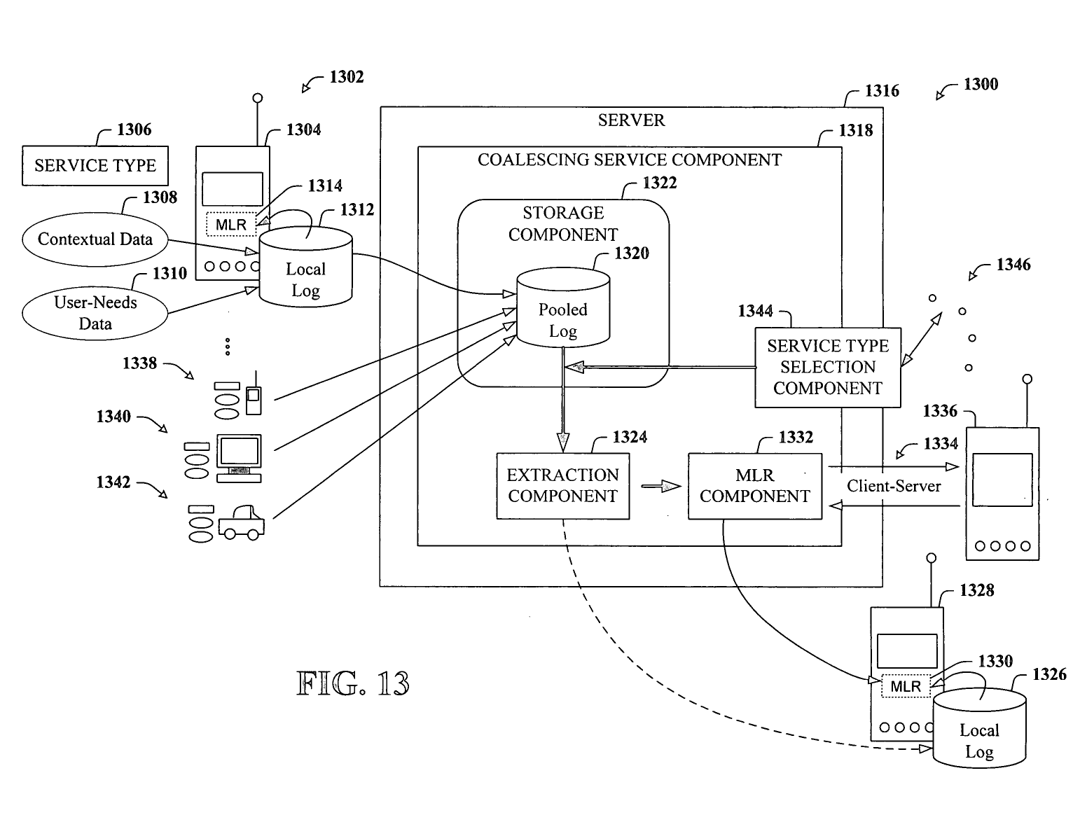

FIG. 13 illustrates a system 1300 that facilitates the capture and processing of data from multiple devices in accordance with an innovative aspect. The system 1300 can leverage the capture of logs from one or more multiple devices 1302 (which can be anonymized to protect the privacy of vendors and clients), the logs can include various types of information such as requests, queries, activities, goals, and needs of people, conditioned on contextual cues like location, time of day, day of week, etc., so as to enhance statistical models (e.g., with updated prior and posterior probabilities about individuals) given contextual cues. Data collected on multiple devices 1302 and shared via data services can be used to update the statistical models on how to interpret utterances of people speaking different languages.

Here, a remote device 1304 is associated with a service type 1306, contextual data 1308 and user-needs data 1310, one or more of which can be stored local to the device 1304 in a local log 1312. The contextual data 1308 can include location, language, temperature, day of week, time of day, proximal business type, and so on. Where the device 1304 includes additional capability such as that associated with an MLR component 1314, logged data can be accessed thereby and utilized to enhance performance of the device 1304. Additionally, data from the local log 1312 of the device 1304 can be communicated to a central server 1316. As a simple example, popular routes between locations may be taken by tourists in a country. Thus, statistics of successful translations made by taxi drivers, even if initially associated with a struggle to get to an understanding, can be captured as sets of cases of utterances and routes (the locations of starts and ends of trips). The case library can be used in an MLR component, for example.

In this exemplary illustration, the system 1300 can include the server 1316 disposed on a network (not shown) that provides services to one or more client systems. The server 1316 can further include a data coalescing service component 1318. As indicated previously, the multiple devices 1302, including those in ongoing service, can be used to collect data and transmit this data back to the data coalescing service component 1318, along with key information about the service-provider type 1306 (e.g., for a taxi, “taxi”), contextual data 1308 (e.g., for a taxi service, the location of pickup, time of day, day of week, and visual images of whether the person was carrying bags or not), and user-needs data 1310 (e.g., the initial utterance or set of utterances, and the final destination the user got out of a taxi). This data can be “pooled” in a pooled log 1320 of a storage component 1322.

Multiple (or one or more) case libraries can be created by extracting subsets of cases from the pooled log 1320 based on properties, using an extraction component 1324. The subsets of cases can include, for example, a database of “all data from taxi providers.” The data can be redistributed out to devices (e.g., to a local log 1326 of a device 1328) for local machine learning and reasoning (MLR) processing via a local MLR component 1330 of the device 1328, and/or an MLR component 1332 can be created centrally at the server 1316 and data distributed (e.g., from the MLR component 1332 to the local MLR component 1330 of the device 1328). Accordingly, learning from or transmission of the one or more case libraries can be performed, as well as portions of one or more case libraries, and/or reasoning models learned from the one or more case libraries can be transmitted to another remote user device for updating thereof.

In another alternative example, the service can created based on the central MLR 1332, and this can be accessed from a remote device 1336 through a client-server relationship 1334 established between the remote device 1336 and the server 1316.

Additional local data can be received from other devices 1302 such as another remote device 1338, a remote computing system 1340, and a mobile computing system associated with a vehicle 1342.

There can be combinations of local logs and central logs, as well as local and central MLR components in the disclosed architecture, including the use of the central service when the local service realizes that it is having difficulty.

The system 1300 also includes a service type selection component 1344 that is employed to facilitate creation of case libraries based on the type of service selected from a plurality of services 1346.

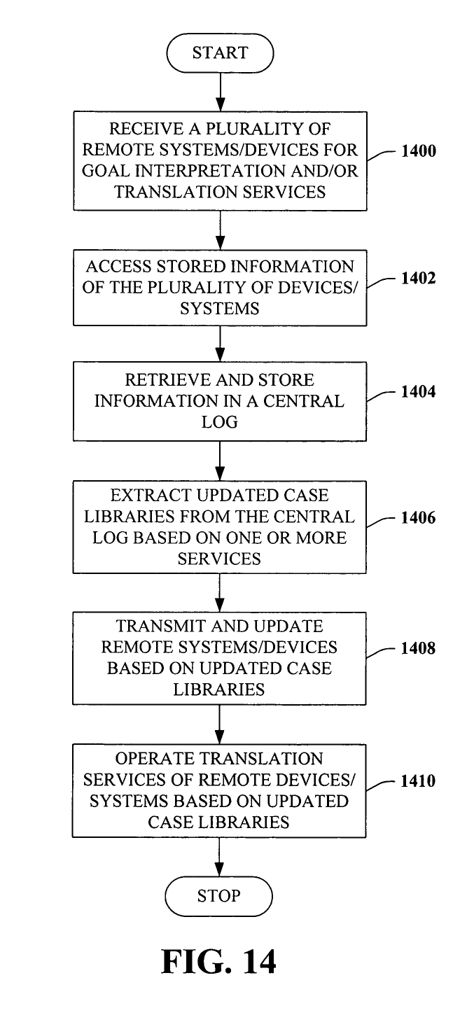

FIG. 14 illustrates a flow diagram of a methodology of capturing logs from remote devices. At 1400, a plurality of remote devices/systems is received for goal interpretation and/or translation services. At 1402, information stored or logged in one or more of the remote systems/devices is accessed for retrieval. At 1404, the information is retrieved and stored in a central log. At 1406, updated case library(ies) can be extracted from the central log based on one or more selected services. At 1408, the updated case library(s) are transmitted and installed in the remote systems/devices. At 1410, the remote systems/devices are operated for translation and/or goal interpretation based on the updated case library(ies).

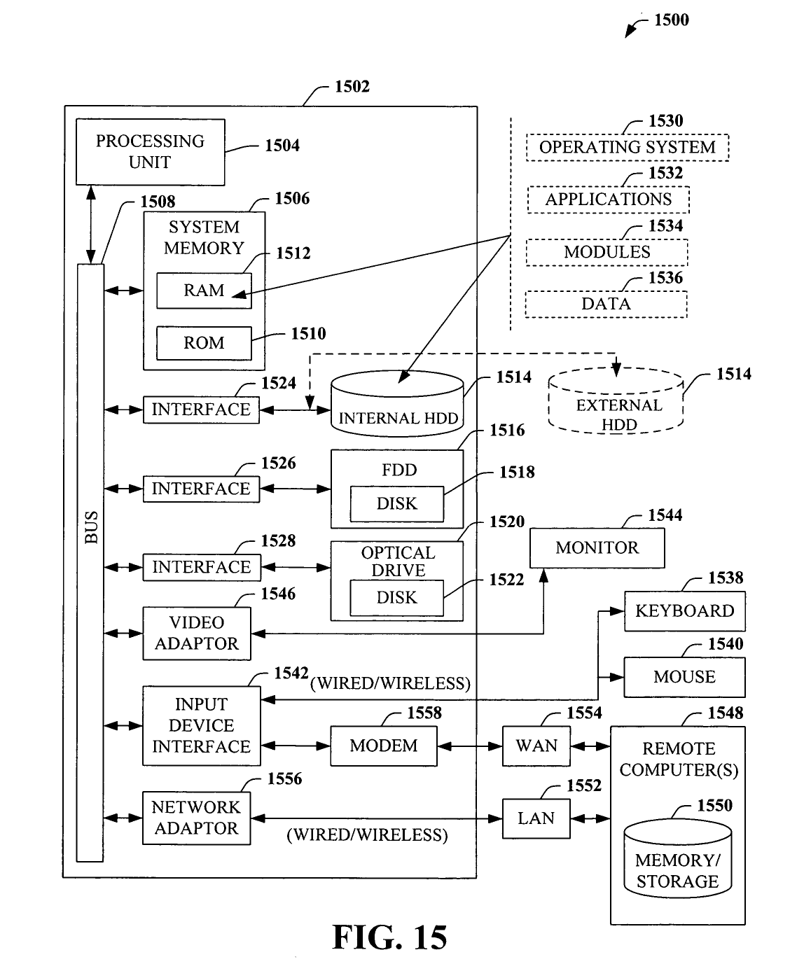

Referring now to FIG. 15, there is illustrated a block diagram of a computer (e.g., portable) operable to execute the disclosed person-to-person communications architecture. In order to provide additional context for various aspects thereof, FIG. 15 and the following discussion are intended to provide a brief, general description of a suitable computing environment 1500 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 15, the exemplary environment 1500 for implementing various aspects includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is to be appreciated that the innovation can be implemented with various commercially available operating systems or combinations of operating systems.

A user can enter commands and information into the computer 1502 through one or more wired/wireless input devices, e.g., a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which may connect to a global communications network, e.g., the Internet.

When used in a LAN networking environment, the computer 1502 is connected to the local network 1552 through a wired and/or wireless communication network interface or adapter 1556. The adaptor 1556 may facilitate wired or wireless communication to the LAN 1552, which may also include a wireless access point disposed thereon for communicating with the wireless adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11 a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10 BaseT wired Ethernet networks used in many offices.

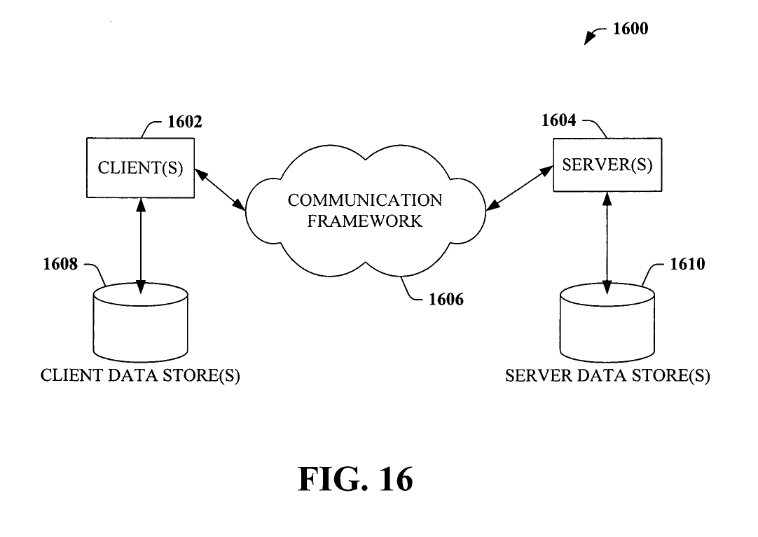

Referring now to FIG. 16, there is illustrated a schematic block diagram of an exemplary computing environment 1600 in accordance with another aspect of the person-to-person communications architecture. The system 1600 includes one or more client(s) 1602. The client(s) 1602 can be hardware and/or software (e.g., threads, processes, computing devices). The client(s) 1602 can house cookie(s) and/or associated contextual information by employing the subject innovation, for example.

The system 1600 also includes one or more server(s) 1604. The server(s) 1604 can also be hardware and/or software (e.g., threads, processes, computing devices). The servers 1604 can house threads to perform transformations by employing the invention, for example. One possible communication between a client 1602 and a server 1604 can be in the form of a data packet adapted to be transmitted between two or more computer processes. The data packet may include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for person-to-person communications, comprising:
a communications component that facilitates communications between two people who are located in a context;
a configuration component that configures the communications component based on the context in which at least one of the two people is located; and
a recognition component that captures and analyzes context data of the context, and recognizes an attribute of the context data that is processed and utilized by the configuration component to facilitate the communications between the two people.

2. The system of claim 1, wherein the communications component is employed between a vendor and a customer of the vendor.

3. The system of claim 1, wherein the communications component is employed for speech communications between a first person who speaks a first language and a second person who speaks a different language.

4. The system of claim 1, wherein the context data includes features of one of the two people, which features include at least one of voice signals, skin color, attire, body frame, objects being carried, and facial constructs.

5. The system of claim 1, further comprising a feedback component that facilitates the processing of feed back information received from at least one of the two people and the recognition component.

6. The system of claim 1, further comprising a context interpretation component that receives and processes one or more of the context data attributes and estimates the context in which the two people are located.

7. The system of claim 1, further comprising a language model component that stores language models that facilitate communications between the two people who speak different languages.

8. The system of claim 7, wherein the language model component stores at least one of a primary language model that facilitates language translation of a general geographical area, and a secondary language model that facilitates language translation between the two people in a specific context environment.

9. The system of claim 8, wherein the specific context environment is a commercial environment that includes transactional language between the two people.

10. The system of claim 1 is deployed in a specific content environment in a predetermined configuration that facilitates the person-to-person communications between the two people who speak different languages.

11. The system of claim 1, further comprising a communications input/output (I/O) selection component that selects a type of communications that is presented between the two people.

12. The system of claim 11, wherein the type of communications selected is based at least on the context, the context data, and characteristics of one of the two people.

13. The system of claim 1, further comprising a machine learning and reasoning component that employs a probabilistic and/or statistical-based analysis to prognose or infer an action that a user desires to be automatically performed.

14. A computer-implemented method of providing person-to-person communications, comprising:
deploying a system in a type of context in which two people who speak different languages desire to communicate;
initializing the system by capturing and analyzing context data of the context;
recognizing an attribute of the context data, which attribute is related to physical characteristics of the context;
processing the attribute to estimate the type of context;
selecting a language model based on the type of context; and
processing the language model to facilitate communications between the two people.

15. The method of claim 14, further comprising an act of selecting a type of I/O that is utilized for communications between the two people based on the context, which is a commercial context.

16. The method of claim 14, further comprising at least one of the acts of:
pooling data received from a plurality of remote user devices in a central log;
processing the received data into one or more case libraries; and
learning from or transmitting the one or more case libraries, portions of one or more case libraries, and/or reasoning models learned from the one or more case libraries to another remote user device for updating thereof.

17. The method of claim 14, wherein the language model includes terms and phrases commonly associated with the context, which is a commercial context.

18. The method of claim 14, further comprising an act of converting the context data into words and/or phrases that are translated into the different languages which are associated with the language model

19. The method of claim 14, further comprising an act of receiving and processing geolocation signals which are utilized to select the language model.

20. A computer-executable system that facilitates person-to-person communications between people that speak different languages, comprising:
computer-implemented means for deploying a personal communications system in a type of commercial context in which the people who speak the different languages desire to communicate;
computer-implemented means for initializing the personal communications system by capturing and analyzing context data of the commercial context;
computer-implemented means for processing the context data and estimating the type of commercial context;
computer-implemented means for selecting primary and secondary language models based on the type of commercial context; and
computer-implemented means for processing the primary and secondary language models to facilitate translated communications between the people.
